(19) United States
(12) Patent Application Publication
(10) Pub. No.: US 2011/0165397 A1
(43) Pub. Date: Jul. 7, 2011

(54) Stitch-Bonded Flame-Resistant Fabrics

(76) Inventors: Ray Roe, Colonial Heights, VA (US); Brenda Marion, McKenney, VA (US); Jeff Siffert, Chesterfield, VA (US); Leon Green, Pompano Beach, FL (US)

(21) Appl. No.: 12/985,638

(22) Filed: Jan. 6, 2011

Related U.S. Application Data
(60) Provisional application No. 61/292,612, filed on Jan. 6, 2010.

(51) Int. Cl. B32B 5/08; D04H 1/42; D04H 13/00; B32B 15/08; B32B 15/14; D05B 3/00

(52) U.S. Cl. 428/219; 442/402; 442/405; 442/407; 442/403; 442/366; 442/378; 112/475.17

(57) ABSTRACT

A fire-resistant fabric is provided that comprises a non-woven batt comprising an intertwined first plurality of flame-resistant fibers. The fire-resistant fabric further comprises one or more stitching yarns engaging the non-woven batt in the form of stitches configured for binding the intertwined flame-resistant fibers into a stitch-bonded fabric. The one or more stitching yarns include a yarn comprising a second plurality of flame-resistant fibers. At least one of the first and second pluralities of flame-resistant fibers comprises partially oxidized PAN fibers.

### CROSS REFERENCE TO RELATED APPLICATION

This application claims priority to U.S. Provisional Application No. 61/292,612, filed Jan. 6, 2010, which is incorporated herein by reference in its entirety.

### BACKGROUND

The present invention relates generally to flame-resistant fabrics and, more particularly, to stitch-bonded flame-resistant fabrics that make use of partially oxidized polyacrylonitrile (“PAN”) fibers and/or yarn.

PAN fibers are flame-resistant carbon precursor fibers made by pyrolytic carbonization of modified acrylic fibers. As described in U.S. Pat. Nos. 6,959,855 and 6,696,374, the disclosures of which are incorporated herein by reference in their entirety, non-woven fabrics incorporating PAN fibers can provide distinct advantages in the manufacture of flame-resistant materials for use in welding and other applications.

U.S. Pat. No. 7,703,405, the disclosure of which is incorporated herein by reference in its entirety, discloses a method of stitch-bonding certain non-woven flame-resistant materials to produce fabrics that are resistant to deformation and degradation such as may result from excessive handling or washing.

The present invention provides fabrics that combine the advantages of PAN materials and the use of stitch-bonding to produce durable, economical, high performance flame-resistant fabrics.

### SUMMARY OF THE INVENTION

An aspect of the invention provides a fire-resistant fabric comprising a non-woven batt comprising an intertwined first plurality of flame-resistant fibers. The fire-resistant fabric further comprises one or more stitching yarns engaging the non-woven batt in the form of stitches configured for binding the intertwined flame-resistant fibers into a stitch-bonded fabric. The one or more stitching yarns include a yarn comprising a second plurality of flame-resistant fibers. At least one of the first and second pluralities of flame-resistant fibers comprises partially oxidized PAN fibers.

Another aspect of the invention provides a method of forming a fire-resistant fabric. The method comprises providing a first plurality of flame-resistant fibers and intertwining the first plurality of flame-resistant fibers to form a batt. The method further comprises stitching the batt with one or more stitching yarns to bind the intertwined flame-resistant fibers of the batt into a stitch-bonded fabric. The one or more stitching yarns include a yarn comprising a second plurality of flame-resistant fibers. At least one of the first and second pluralities of flame-resistant fibers comprises partially oxidized PAN fibers.

### BRIEF DESCRIPTION OF THE DRAWINGS

FIG. 1 is a side view of a non-woven fiber batt that may be used in embodiments of the invention;

FIG. 2 is a top plan view of a portion of a fire-resistant fabric according to an embodiment of the invention;

FIG. 3 is a bottom plan view of a portion of a fire-resistant fabric according to an embodiment of the invention;

FIG. 4 is a section view of the portion of fire-resistant fabric of FIG. 2; and

FIG. 5 is a section view of a portion of a fire-resistant fabric according to an embodiment of the invention.

### DETAILED DESCRIPTION OF THE INVENTION

Embodiments of the present invention provide flame-resistant fabrics and methods of manufacturing such fabrics. Representative embodiments provide fabrics in the form of a non-woven batt, which typically has a higher loft structure than a woven or knitted fabric. The non-woven batt is stitch-bonded to form a washable, durable, reusable fabric. The end product is therefore potentially cheaper for a consumer because it is reusable and more durable than woven or knitted fabrics.

The terms “fire-resistant” and “flame-resistant” are used interchangeably herein to describe fabrics and other materials that burn slowly or that are self-extinguishing after removal of an external source of ignition. The term “flame-retardant” is used herein to describe fabrics and other materials that, due to chemical treatment or inherent properties, do not ignite readily or propagate flame under small-to-moderate fire exposure.

The fabrics of the invention have fire-resistant properties that help prevent the ignition of articles when exposed to high heat or a flame source. The fabric may thus be used in a variety of different articles including, but not limited to, blankets, covers, clothing, and other apparel for protecting personal property, people, or structures from flames and high heat sources. The fabric is designed to insulate people and/or property from a high heat or flame source and prevent damages or burns to people and/or property.

Fire-resistant fabrics may be formed from high performance fibers, such as aramid, melamine, PAN, or a combination thereof. High-performance fibers are driven by special technical functions that require specific physical properties unique to these fibers. They usually have very high levels of at least one of the following properties: tensile strength, operating temperature, limiting oxygen index, and chemical resistance. Each high performance fiber type has a unique combination of properties that allows it to fill a niche in the upper end of the high-performance fiber spectrum. High-performance fabrics are typically technically driven, specialty oriented, and made with smaller batch-type production.

Of particular interest in many applications are carbon precursor fibers, which are made by pyrolytic carbonization of a modified acrylic fiber. They are partially carbonized fibers that transform into carbon or graphite fibers when they undergo further carbonization in an inert atmosphere at high temperature. Carbon precursor fibers combine a high operating temperature with excellent flame resistance.

Polymerization of acrylonitrile produces PAN (see table 1 below), which is the most common carbon fiber feedstock. The basic unit of PAN is:

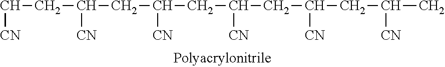

Oxidation involves heating the fibers to around 300° C. in air, which evolves hydrogen from the fibers and adds less volatile oxygen:

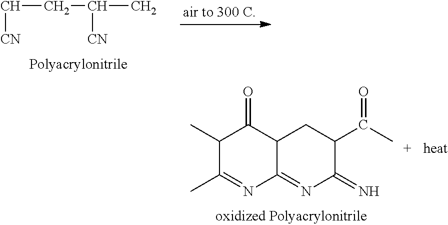

The polymer changes from a ladder to a stable ring structure, and the fiber changes color from white to black. Table 1 below shows a partial listing of brand names for carbon precursor fibers and fabrics formed from such fibers.

TABLE 1

Fortafil ® carbon or graphite fibers
Hexcel ® carbon fibers
Lastan ™ carbon fibers
Panox ® oxidized polyacrylonitrile fibers
Panotex ® flame-resistant fabric
Pavenex ® flame-resistant fabric
Tenax ® carbon fibers
Torayca ® carbon fiber yarn
Thornel ® carbon or graphite fibers

Some embodiments of the present invention provide a fire-resistant high heat blocking fabric comprising a lightweight, pliant, non-woven batt formed primarily or exclusively of partially oxidized PAN fibers that are intertwined and then stitch-bonded. The resulting fabric is durable, reusable, and washable.

In some embodiments of the invention, a fire-resistant fabric may be formed from PAN or other flame-resistant fibers and stitch-bonded with a yard or thread formed from PAN or other flame-resistant fibers.

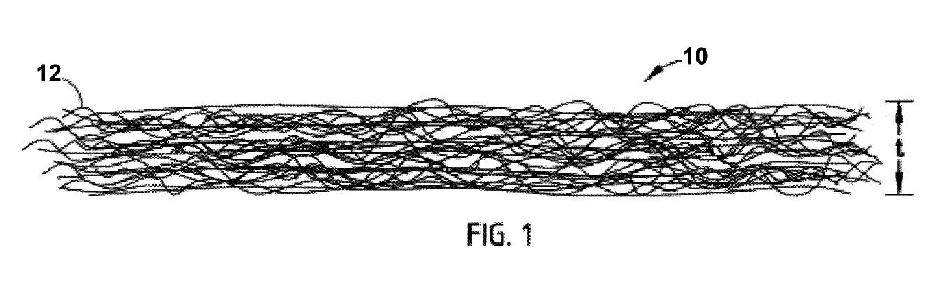

An aspect of the present invention provides a method of manufacturing a fire-resistant, high heat blocking fabric. The method comprises the steps of: providing a plurality of fibers including or exclusively consisting of flame-resistant fibers. In particular embodiments, the plurality of fibers comprises primarily or exclusively partially oxidized PAN fibers. The method further comprises intertwining the fibers into a non-woven batt. With reference to FIG. 1, a non-woven batt 10 comprises a plurality of fibers 12 formed as a substantially flat section of material having a generally uniform average thickness t. The fibers 12 are combined in such a way that, if multiple fiber types are used, each of the different types of fiber is substantially uniformly dispersed throughout the batt 10.

The action of intertwining the fibers 12 may include a process known in the industry as “needling” or “needle punching.” Needling mechanically moves each fiber in the X, Y, and Z-directions to intermingle the fibers. This is accomplished by combining and uniformly distributing the fibers in their relative desired proportions and delivering them to a needling apparatus where a plurality of needle-like projections engage and intertwine the fibers in such a manner as to substantially interlock the fibers 12 to form the batt 10 with the desired thickness t. The Z-directional strength and controlled fiber orientation improves shear strength and reduces the potential of ply delamination, or fiber separation.

The weight and distribution of fibers used to form the batt 10 may be selected to provide particular properties or weights. In a particular embodiment, the batt 10 is formed from partially oxidized PAN fibers, alone or in combination with one or more other fiber types to produce a non-woven batt having a weight of approximately 3 to 12 ounces per square yard.

The batt 10 may be formed exclusively from partially oxidized PAN fibers. In some embodiments of the present invention, other fire-resistant fibers are combined with partially oxidized PAN fibers to form the batt 10. These other fire-resistant fibers may include, for example, aramid and/or melamine fibers. In some embodiments, the other fire-resistant fibers could include flame-retardant fibers, including but not limited to cellulosic fibers such as Visil® and chemically treated polyester, rayon, nylon, or cotton. The weight ratio of partially oxidized PAN fibers to other fire-resistant fibers will typically be in a range of approximately 95/5 to about 60/40. In some embodiments, the weight ratio of partially oxidized PAN fibers to other fire-resistant fibers will be in a range of approximately 90/10 to about 70/30.

The non-woven batt 10 of flame-resistant fibers 12 may be stitch-bonded to form a stitch-bonded flame-resistant fabric. Stitch-bonding the non-woven material serves to prevent deformation, pulling or dislodging of the fibers 10 during use, manipulation or washing. In embodiments of the present invention, the fire-resistant fibers are stitch-bonded with a yarn or thread comprising fire-resistant materials. The yarn or thread may comprise various fiber types including, but not limited to, aramid fibers, melamine fibers, polyester fibers, and chemically treated flame-retardant fibers such as chemically treated polyester, rayon, nylon or cotton fibers. Of particular interest are embodiments in which a fire-resistant batt is stitch-bonded with a yarn formed from partially oxidized PAN fibers.

In some embodiments, the yarn used to stitch bond the non-woven batt 10 may comprise or consist of fibers that are the same material as that used to form the batt. In a particular embodiment, a batt comprising or consisting of partially oxidized PAN fibers may be stitch-bonded with a yarn comprising or consisting of partially oxidized PAN fibers.

The non-woven batt 10 may be stitch-bonded in any manner suitable for maintaining the stability of the resulting fabric. The yarns or threads can be stitched/knitted in continuous loops in both the warp and weft directions as needed. In some embodiments, the warp direction yarn may be stitched/knitted in straight rows of loops. These can be any gauge in a range of 14 threads per inch to less than 1 per inch.

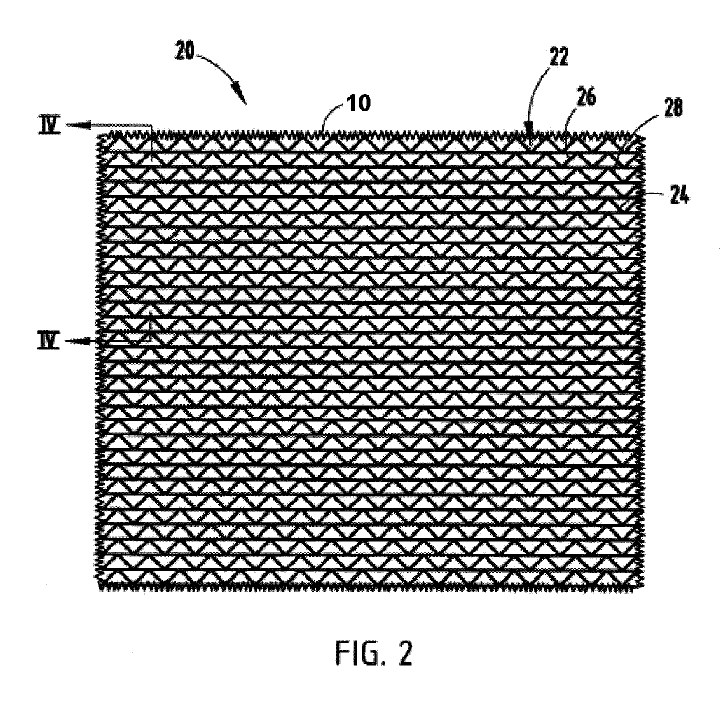

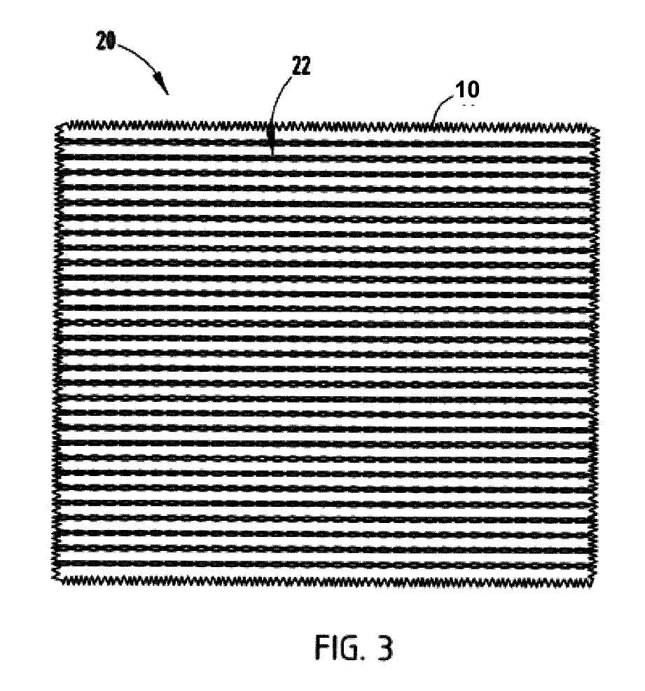

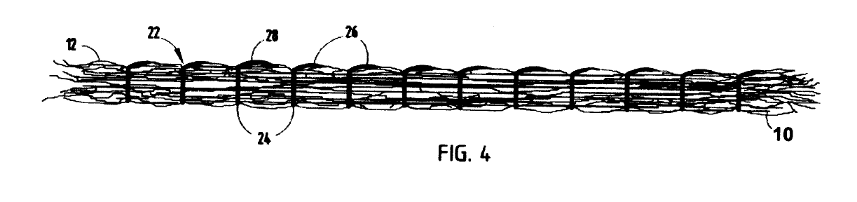

Particularly suitable methods involve the use of chain stitches and/or tricot stitches. With reference to FIGS. 2-4, an exemplary embodiment of a fire-resistant fabric 20 is formed from a non-woven batt 10 by stitch-bonding. The resultant fire-resistant fabric 20 comprises a repeated pattern of parallel rows 22 of stitching. The parallel rows 22 include “chain” stitches 24 and “tricot” stitches 26. The tricot stitches 26 exhibit a zigzag or herringbone pattern in which the stitching threads extend through one surface of the batt 10. FIG. 2 shows a plan view of the fabric surface through which the tricot stitches are formed. FIG. 3 shows a plan view of the opposite fabric surface, through which only the chain stitches are passed. FIG. 4 shows a cross-section of the fabric 20. The rows of chain stitches 24 and tricot stitches 26 may be positioned so that the rows are adjacent but unconnected or may be physically connected. In some embodiments, the parallel rows 22 of chain stitches 24 and tricot stitches 26 may be spaced so that the center of each row is spaced from the center of each adjacent row by approximately 1/7 inch. Other spacings may be used depending on the fabric's intended use.

In other embodiments, the stitch-bonding may comprise only chain stitches, formed in parallel rows. In some embodiments, two chain stitched rows run parallel and in opposition to one another. Again the two rows of stitching may be spaced approximately 1/7 inch apart from each other, but may be spaced closer or farther apart depending on the fabric's intended use.

The material and weight of the yarn used to stitch-bond the fire-resistant fabrics of the invention may be tailored to the materials of the fire-resistant batt and/or the intended application of the fabric. In an illustrative embodiment of the invention, a batt comprising or consisting of partially oxidized PAN fibers may be stitch-bonded with a yarn formed from fire-resistant fibers to produce a flame-resistant fabric having a finished weight in a range of about 3 to about 12 ounces per square yard.

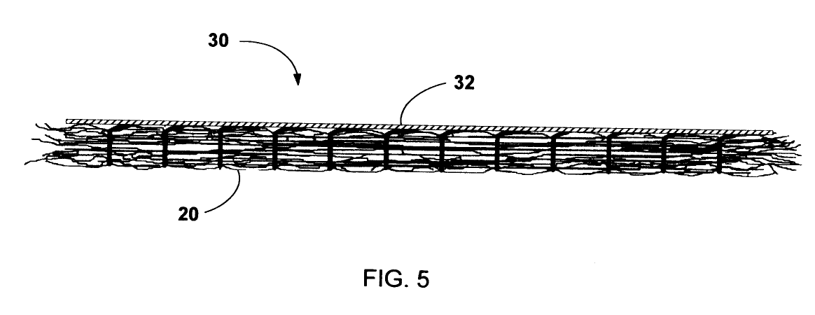

With reference to FIG. 5, a composite fire-resistant fabric 30 of the invention may include a stitch-bonded base fabric 20 formed according to any of the above-described embodiments and further including a layer of metal 32 adhered to one surface of the fabric 20 to provide additional thermal protection. In particular embodiments, the metal layer 32 comprises or consists of a thin coating of aluminum deposited on the surface of the fabric 20. The aluminum layer may be deposited so as to add weight to the fabric in a range of about 3 to about 8 ounces per square yard. A typical overall weight of the fire-resistant fabric is in a range of 6 to 20 ounces per square yard.

The flame-resistant fabrics of the invention have wide application as insulation materials, weld curtains and hot work protection. They are also usable in the manufacture of protective apparel for use by industrial welders or others requiring protection in high-heat or flame-producing environments.

While the present invention has been described here in detail in relation to its preferred embodiment, it is to be understood that this disclosure is only illustrative and exemplary of the present invention and is made merely for the purposes of providing a full and enabling disclosure of the invention. Many other embodiments and modifications to the embodiments described above can be made without departing from the spirit and scope of the invention. Accordingly, the foregoing disclosure is not intended to be construed to limit the present invention or otherwise to exclude any other such embodiments, adaptations, variations, modifications and equivalent arrangements.

What is claimed is:

1. A fire-resistant fabric comprising:
a non-woven batt comprising an intertwined first plurality of flame-resistant fibers; and
one or more stitching yarns engaging the non-woven batt in the form of stitches configured for binding the intertwined flame-resistant fibers into a stitch-bonded fabric, the one or more stitching yarns including a yarn comprising a second plurality of flame-resistant fibers,
wherein at least one of the set consisting of the first and second pluralities of flame-resistant fibers comprises partially oxidized polyacrylonitrile fibers.

2. A fire-resistant fabric according to claim 1 wherein the non-woven consists of intertwined partially oxidized polyacrylonitrile fibers.

3. A fire-resistant fabric according to claim 1 wherein the first plurality of flame-resistant fibers comprises a blend of partially oxidized polyacrylonitrile fibers and other flame-resistant fibers.

4. A fire-resistant fabric according to claim 3 wherein the other flame-resistant fibers comprise one or more of the set consisting of aramid fibers, melamine fibers and flame-retardant cellulosic fibers.

5. A fire-resistant fabric according to claim 3 wherein a weight ratio of the partially oxidized polyacrylonitrile fibers to the other flame-resistant fibers is in a range of about 95/5 to about 60/40.

6. A fire-resistant fabric according to claim 3 wherein a weight ratio of the partially oxidized polyacrylonitrile fibers to the other flame-resistant fibers is in a range of about 90/10 to about 70/30.

7. A fire-resistant fabric according to claim 1 wherein the first plurality of flame-resistant fibers comprises one or more of the set consisting of aramid fibers and melamine fibers and the second plurality of flame-resistant fibers comprises partially oxidized polyacrylonitrile fibers.

8. A fire-resistant fabric according to claim 1 wherein the first plurality of flame-resistant fibers comprises one or more of the set consisting of aramid fibers and melamine fibers and the second plurality of flame-resistant fibers consists of partially oxidized polyacrylonitrile fibers.

9. A fire-resistant fabric according to claim 1 wherein the first plurality of flame-resistant fibers comprises partially oxidized polyacrylonitrile fibers and the second plurality of flame-resistant fibers comprises at least one of the set consisting of aramid fibers, melamine fibers, polyester fibers, and chemically treated flame-retardant fibers.

10. A fire-resistant fabric according to claim 9 wherein the chemically treated flame-retardant fibers are selected from the set consisting of polyester fibers, rayon fibers, nylon fibers and cotton fibers.

11. A fire-resistant fabric according to claim 1 wherein at least a portion of the stitches are formed in parallel rows.

12. The fabric according to claim 10, wherein the parallel rows are spaced at approximately 1/7 inch intervals.

13. A fire-resistant fabric according to claim 1 wherein the stitches comprise alternating parallel rows of chain stitches and tricot stitches.

14. A fire-resistant fabric according to claim 1 having a finished weight in a range of about 3 ounces per square yard to about 12 ounces per square yard.

15. A fire-resistant fabric according to claim 1 further comprising a metal layer adhered to a surface of the stitch-bonded fabric.

16. A fire-resistant fabric according to claim 14 wherein the metal layer comprises aluminum deposited on the surface of the stitch-bonded fabric in a weight range of 3 ounces per square yard to 8 ounces per square yard.

17. A method of forming a fire-resistant fabric comprising:
providing a first plurality of flame-resistant fibers;
intertwining the first plurality of flame-resistant fibers to form a batt; and
stitching the batt with one or more stitching yarns to bind the intertwined flame-resistant fibers of the batt into a stitch-bonded fabric, the one or more stitching yarns including a yarn comprising a second plurality of flame-resistant fibers,
wherein at least one of the set consisting of the first and second pluralities of flame-resistant fibers comprises partially oxidized polyacrylonitrile fibers.

18. A method according to claim 16 wherein the action of intertwining includes needling the first plurality of flame-resistant fibers.

19. A method according to claim 16 wherein the non-woven consists of intertwined partially oxidized polyacrylonitrile fibers.

20. A method according to claim 16 wherein the first plurality of flame-resistant fibers comprises a blend of partially oxidized polyacrylonitrile fibers and other flame-resistant fibers.

21. A method according to claim 16 further comprising:
depositing a layer of aluminum on a surface of the stitch-bonded fabric.
